(19) United States
(12) Patent Application Publication
(10) Pub. No.: US 2021/0404703 A1
(43) Pub. Date: Dec. 30, 2021

(54) DUCT SOUNDPROOFING DEVICE AND SYSTEM

(71) Applicant: Sean Christopher McCann, Virgil (CA)

(72) Inventor: Sean Christopher McCann, Virgil (CA)

(21) Appl. No.: 16/910,150

(22) Filed: Jun. 24, 2020

(51) Int. Cl. F24F 13/24

(52) U.S. Cl. CPC F24F 13/24; F16L 55/033; F24F 2013/245

(57) ABSTRACT

A soundproofing device; the soundproofing device includes a body and a set of soundproofing sections disposed therein. In some embodiments, a soundproofing system is also disclosed herein and includes a set of soundproofing devices. The soundproofing device and the soundproofing system are useful for easy installation into ductwork of a building to provide substantial soundproofing to the same.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of soundproofing systems and devices of existing art and more specifically relates to systems and devices for soundproofing ductwork in a building.

### RELATED ART

Ducts are conduits used in heating, ventilation, and air conditioning (HVAC) systems to deliver and remove air from a building. Ducts feed or receive air to and from air vents located in various rooms of the building. Whilst this is beneficial for conveying air throughout the building, a disadvantage of ductwork is that sound waves being carried by the air are also conveyed through the ductwork and out through air vents—meaning that the ductwork provides a path for noise to travel from one room to another. This is a problem as it not only carries loud noises throughout the house, but also carries private conversations and provides a means of eavesdropping, particularly for children.

Existing practices for soundproofing buildings are typically very costly and time-consuming as they require structural changes to the building. Further, there are limitations with existing soundproofing practices as some areas of ductwork, particularly ducts passing directly from one room to another, are currently unable to be soundproofed. Thus, a suitable solution is desired.

### SUMMARY OF THE INVENTION

In view of the foregoing disadvantages inherent in the known soundproofing art, the present disclosure provides a novel duct soundproofing device and system. The general purpose of the present disclosure, which will be described subsequently in greater detail, is to provide a device and system for easy installation into ductwork of a building to provide substantial soundproofing to the same. The device and system may be configured to substantially inhibit sound waves from travelling from room to another, thus preventing the ability to eavesdrop via in room air vents.

A soundproofing device is disclosed herein. The soundproofing device may be configured for installation into a duct of a building; the duct including an outer duct-shell and an inner duct-channel and configured to convey airflow (carrying sound waves) throughout the building via the inner duct-channel. The soundproofing device includes a body including an outer body-shell and an inner body-channel. The body may be configured for insertion into a section of the inner-duct channel such that the airflow travels through the inner body-channel when inserted. Further, a set of soundproofing sections may be disposed within the inner body-channel. Each soundproofing section may be configured and arranged in such a way as to inhibit conveyance of the sound waves through the inner-body channel whilst allowing airflow to travel therethrough substantially uninhibited.

According to another embodiment, a soundproofing system is also disclosed herein. The soundproofing system includes a set of soundproofing devices each including the body and the set of soundproofing sections as discussed above.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a duct soundproofing device and system, constructed and operative according to the teachings of the present disclosure.

FIG. 1 is a perspective view of a soundproofing device and a soundproofing system during an ‘in-use’ condition, according to an embodiment of the disclosure.

FIG. 2 is a front view of the soundproofing device of FIG. 1, according to an embodiment of the present disclosure.

FIG. 3 is a side front view of the soundproofing device of FIG. 1, according to an embodiment of the present disclosure.

FIG. 4 is a top view of the soundproofing device of FIG. 1, according to an embodiment of the present disclosure.

FIG. 5 is a side top dissected view of the soundproofing device of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to soundproofing devices and systems and more particularly to a duct soundproofing device and system as used to substantially inhibit sound waves from travelling from room to another via ductwork in a building, thus preventing the ability to eavesdrop via in room air vents.

Generally disclosed is a soundproofing device. The soundproofing device preferably includes a body that is insertable into a duct of the building. When inserted, airflow being conveyed via the duct may be forced into the body. Located in an interior of the body may be sections arranged and configured to absorb and redirect sound waves being carried by the airflow. The sections preferably form a maze for the airflow. The body and the sections are both constructed of a foam material such that both the body and sections may work to absorb sound waves.

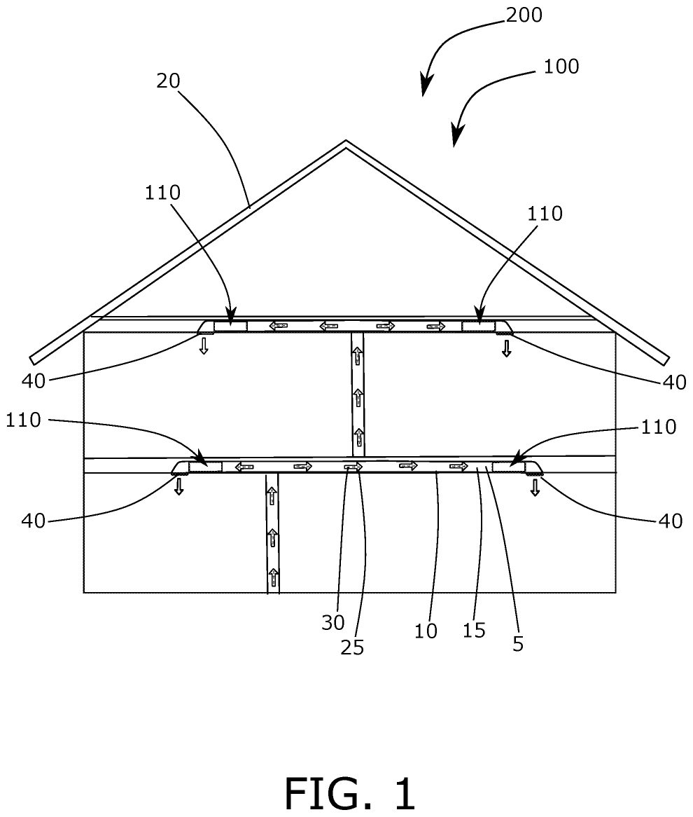

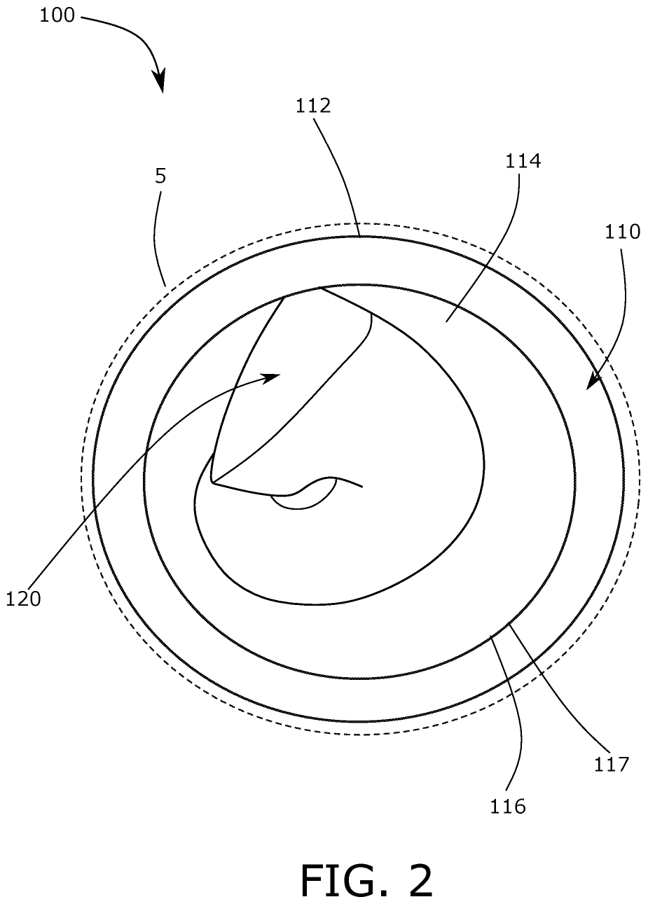

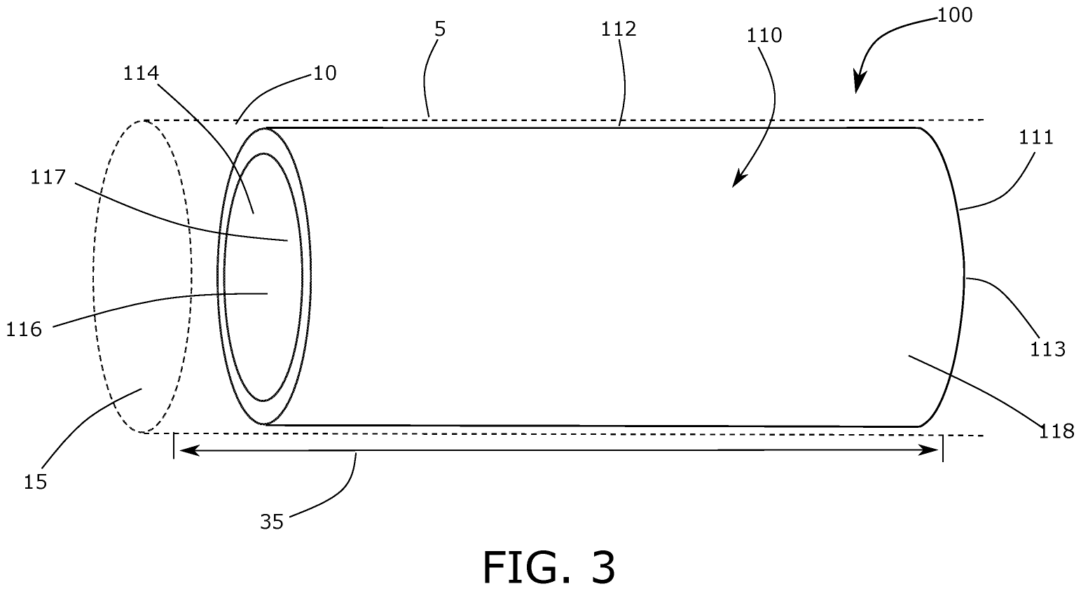

Referring now more specifically to the drawings by numerals of reference, there is shown in FIGS. 1-5, various views of a soundproofing device 100 and a soundproofing system 200 (FIG. 1).

FIGS. 1-3 shows a soundproofing device 100 during an ‘in-use’ condition 150, according to an embodiment of the present disclosure. As illustrated, the soundproofing device 100 may include a body 110 and a set of soundproofing sections 120. As shown, the soundproofing device 100 may be configured for installation into a duct 5 of a building 20. The duct 5 may include an outer duct-shell 10 and an inner duct-channel 15 and may be configured to convey airflow 25 (carrying sound waves 30) throughout the building 20 via the inner duct-channel 15. The soundproofing device 100 may be configured to provide a tortured path for the sound waves 30.

In some embodiments the soundproofing device 100 may be provided as a set within a soundproofing system 200. In the soundproofing system 200, each soundproofing device 100 may be configured for installation into ducts 5 of the building 20.

The body may include an outer body-shell 112; an inner body-channel 114; a first end 111 defining an airflow entrance 113 to the inner body-channel 114; and a second end 116 opposite the first end 111 and defining an airflow exit 117 from the inner body-channel 114. The body 110 may be configured for insertion into a section 35 of the inner-duct channel 15 such that the airflow 25 travels through the inner body-channel 114 when inserted. In some embodiments, the section of the inner duct-channel 15 may be located nearby an in-room vent 40.

Insertion of the body 110 into the section 35 may inhibit sound waves 30 from travelling unimpeded through the in-room air vent 40 so as to substantially soundproof the in-room air vent 40. In the soundproofing system 200 embodiment, each soundproofing device 100 provided may be configured for installation into a separate section of the inner duct-channel 15 such that each in-room air vent 40 is substantially soundproof. For example, a user may install one soundproofing device 100 nearby each in-room air vent 40 of the building 20 to substantially soundproof the ducts of the building 20 and thus substantially prevent eavesdropping therethrough.

The outer body-shell 112 may be configured to abut against the inner duct-channel 15 when the body is inserted in the duct 5. This may block airflow 25 from travelling around the body 110 such that the airflow 25 is forced through the inner-body channel 114 to ensure the sound waves 30 are directed through the tortured path. To aid in this, it is contemplated that the body 110 includes a similar size and shape to the inner duct-channel 15. For example, the inner duct-channel 15 may include a cylindrical profile 118, and likewise, the body 110 may include the cylindrical profile 118.

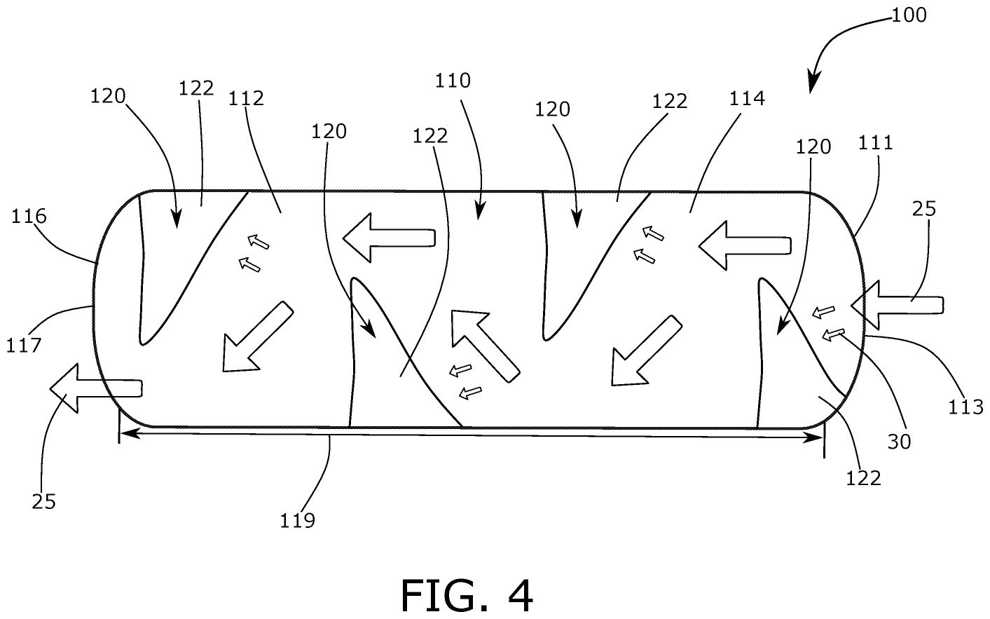

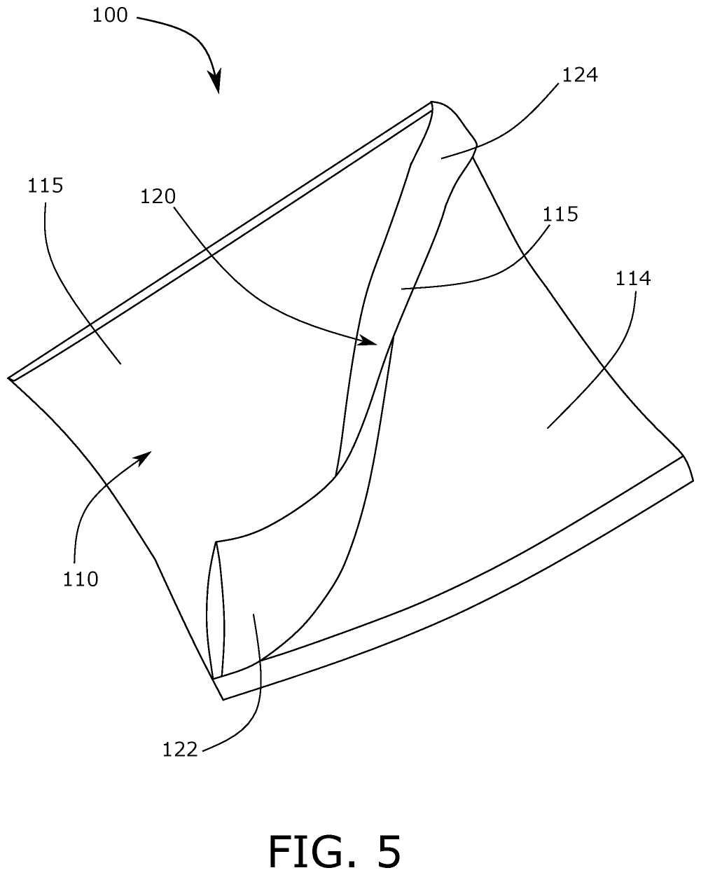

Referring now to FIGS. 4-5 showing various views of the soundproofing device of FIG. 1, according to an embodiment of the present disclosure. The set of soundproofing sections 120 may be disposed within the inner body-channel 114. Each soundproofing section 120 may be configured and arranged in such a way as to inhibit conveyance of the sound waves 30 through the inner-body channel 114 whilst allowing airflow 25 to travel therethrough substantially uninhibited. The set of soundproofing sections 120 maybe configured to redirect the sound waves 30 or to absorb the sound waves 30.

Preferably, the body 110 and each soundproofing section 120 may be constructed from a porous material 115 (preferably foam with air pockets) configured to absorb the sound waves 30. The porous material 115 may be a foam material—particularly an open celled foam material such as acoustic foam. However, it is contemplated that the body 110 and/or each soundproofing section 120 may be made from different materials. For example, each soundproofing section 120 may include a material configured to redirect sound waves 30—such as a wood material.

Each soundproofing section 120 may include a raised end 122 and a lowered end 124. The raised end 122 may be configured to block airflow 25 and force airflow 25 through the lowered end 124, and further may be configured to inhibit conveyance of sound waves 30. The set of soundproofing sections 120 may be arranged throughout a length 119 of the inner body-channel 114, and as above, may be arranged to inhibit conveyance of the sound waves 30 through the inner body-channel 114.

Preferably, the set of soundproofing sections 120 may be arranged in such a way as to force airflow 25 through the inner body-channel 114 in an alternating left and right path 128. Each soundproofing section 120 may be staggered throughout the length 119 of the inner body-channel 114 such that the raised end 122 of each soundproofing section 120 alternates sides of the inner body-channel 114, thus forcing the airflow 25 through the inner body-channel 114 in the alternating left and right path 128 whilst the sound waves 30 are redirected/absorbed by the raised end 122 of each soundproofing section 120. For example, the body 110 may be inserted into the inner duct-channel 15 and once airflow 25 being conveyed through the duct 5 meets the body, it is forced into the airflow entrance 113. As the airflow 25 travels through the inner body-channel 114, the sound waves 30 being carried by the airflow 25 may be absorbed and redirected by each raised end 122 of each soundproofing section 120 whilst the airflow 25 is directed through each lowered end 124 of each soundproofing section 120, thus inhibiting conveyance of the sound waves 30 through the inner-body channel 114 whilst simultaneously allowing airflow 25 to travel therethrough substantially uninhibited. The airflow 25 moves out through the airflow exit 117 carrying substantially less (loud) sound waves 30 than it entered the soundproofing device 100 with.

FIG. 5 illustrates a dissected view of the soundproofing device 100. In this figure the body 110 is shown cut at a side thereof to demonstrate one soundproofing section 120 disposed within the inner body-channel 114. When assembled, each soundproofing section 120 may be arranged in a spiral configuration inside the inner body-channel 114 with the raised end 122 and the lowered end 124 of each soundproofing section terminating on opposing sides of the inner body-channel 114. It is contemplated that the set of soundproofing sections 120 may include at least two (or more) soundproofing sections 120 to provide substantial soundproofing. Those with ordinary skill in the art will now appreciate that upon reading this specification and by their bunderstanding the art of soundproofing foams and devices as described herein, methods of inhibiting conveyance of sound waves such as absorption, redirection, etc. will be understood by those knowledgeable in such art. It should also be noted that, under appropriate circumstances, considering such issues as design preference, user preferences, marketing preferences, cost, structural requirements, available materials, technological advances, etc., other methods for soundproofing ducts in various configurations as per application are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A soundproofing device for installation into a duct of a building, the duct including an outer duct-shell and an inner duct-channel, the duct being configured to convey airflow throughout the building via the inner duct-channel, the airflow carrying sound waves, the soundproofing device to provide a tortured path for said sound waves and comprising:
a body including an outer body-shell and an inner body-channel, the body being configured for insertion into a section of the inner-duct channel such that the airflow travels through the inner body-channel when inserted; and
a set of soundproofing sections disposed within the inner body-channel, each soundproofing section configured and arranged in such a way as to inhibit conveyance of the sound waves through the inner-body channel whilst allowing airflow to travel therethrough substantially uninhibited.

2. The soundproofing device of claim 1, wherein the body is constructed from a porous material.

3. The soundproofing device of claim 2, wherein said each soundproofing section is constructed from the porous material.

4. The soundproofing device of claim 3, wherein the porous material is configured to absorb the sound waves.

5. The soundproofing device of claim 4, wherein the porous material is a foam material.

6. The soundproofing device of claim 5, wherein the foam material is an open celled foam material.

7. The soundproofing device of claim 1, wherein the set of soundproofing sections in combination are configured to redirect the sound waves.

8. The soundproofing device of claim 1, wherein the body includes a first end defining an airflow entrance to the inner body-channel, and wherein the body further includes a second end opposite the first end and defining an airflow exit from the inner body-channel.

9. The soundproofing device of claim 8, wherein the section of the inner duct-channel is located nearby an in-room air vent, and wherein the body is configured for insertion into the section so as to inhibit sound waves from travelling unimpeded through the in-room air vent.

10. The soundproofing device of claim 9, wherein the inner duct-channel includes a cylindrical profile, and wherein the body includes the cylindrical profile.

11. The soundproofing device of claim 10, wherein the outer body-shell is configured to abut against the inner duct-channel when the body is inserted in the duct, blocking airflow from travelling around the body such that the airflow is forced through the inner-body channel.

12. The soundproofing device of claim 1, wherein the set of soundproofing sections are arranged throughout a length of the inner body-channel.

13. The soundproofing device of claim 12, wherein each soundproofing section includes a raised end and a lowered end.

14. The soundproofing device of claim 13, wherein the raised end is configured to block airflow and force airflow through the lowered end.

15. The soundproofing device of claim 14, wherein the raised end is configured to inhibit conveyance of sound waves.

16. The soundproofing device of claim 15, wherein the set of soundproofing sections are arranged in such a way as to force airflow through the inner body-channel in an alternating left and right path.

17. The soundproofing device of claim 16, wherein each said soundproofing section is staggered throughout the length of the inner body-channel such that the raised end of each soundproofing section alternates sides of the inner body-channel.

18. A soundproofing device for installation into a duct of a building, the duct including an outer duct-shell and an inner duct-channel, the duct being configured to convey airflow throughout the building via the inner duct-channel, the airflow carrying sound waves, the soundproofing device to provide a tortured path for said sound waves and comprising:
a body including an outer body-shell, an inner body-channel, a first end defining an airflow entrance, and a second end opposite the first end and defining an airflow exit, the body constructed from a porous material, the body being configured for insertion into a section of the inner-duct channel, airflow entrance first, such that the airflow travels through the inner body-channel when inserted, the outer body-shell being configured to abut against the inner duct-channel when the body is inserted in the duct, blocking airflow from travelling around the body such that the airflow is forced through the inner-body channel; and
a set of soundproofing sections disposed within the inner body-channel, each said soundproofing section constructed from the porous material and including a raised end and a lowered end, the set of soundproofing sections arranged throughout a length of the inner body-channel, each soundproofing section being configured and arranged in such a way as to inhibit conveyance of the sound waves through the inner-body channel whilst allowing airflow to travel therethrough substantially uninhibited, the raised end being configured to block airflow and force airflow through the lowered end, and the raised end further being configured to inhibit conveyance of sound waves; and wherein the set of soundproofing sections are arranged in such a way as to force airflow through the inner body-channel in an alternating left and right path; and
wherein the section of the inner duct-channel is located nearby an in-room air vent, and wherein the body is configured for insertion into the section so as to inhibit sound waves from travelling unimpeded through the in-room air vent.

19. A soundproofing system for installation into ducts of a building, the ducts each including an outer duct-shell and an inner duct-channel, the ducts being configured to convey airflow throughout the building via the inner duct-channel, the airflow carrying sound waves, the soundproofing system comprising:
a set of soundproofing devices, each soundproofing device to provide a tortured path for said sound waves, each soundproofing device including:
a body including an outer body-shell and an inner body-channel, the body being configured for insertion into a section of the inner-duct channel such that the airflow travels through the inner body-channel when inserted; and
a set of soundproofing sections disposed within the inner body-channel, each said soundproofing section configured and arranged in such a way as to inhibit unimpeded conveyance of the sound waves through the inner-body channel whilst allowing airflow to travel therethrough substantially uninhibited.

20. The soundproofing system of claim 19, wherein the section of the inner duct-channel is located nearby an in-room air vent, wherein the body is configured for insertion into the section so as to inhibit sound waves from travelling through the in-room air vent, and wherein each said soundproofing device is configured for installation into a separate section of the inner duct-channel such that each in-room air vent is substantially soundproof.
